(19) United States
(12) Patent Application Publication
(10) Pub. No.: US 2015/0228234 A1
(43) Pub. Date: Aug. 13, 2015

(54) BUFFER CIRCUIT, PANEL MODULE, AND DISPLAY DRIVING METHOD

(71) Applicant: NOVATEK MICROELECTRONICS CORP., HsinChu (TW)

(72) Inventors: Chieh-An LIN, Taipei City (TW); Chun-Yung CHO, Hsinchu County (TW); Jhih-Siou CHENG, New Taipei City (TW)

(73) Assignee: NOVATEK MICROELECTRONICS CORP., HsinChu (TW)

(21) Appl. No.: 14/339,753

(22) Filed: Jul. 24, 2014

(30) Foreign Application Priority Data
Feb. 11, 2014 (TW) 103104354

(51) Int. Cl. G09G 3/36; G05F 3/16

(52) U.S. Cl. CPC G09G 3/3614; G05F 3/16; G09G 2310/0289; G09G 2310/0291; G09G 2310/0297; G09G 2330/021

(57) ABSTRACT

A buffer circuit, a display module, and a display driving method are disclosed. The buffer circuit comprises a positive polarity buffer, a negative polarity buffer. The positive polarity buffer receives a first supply voltage and a second supply voltage to output a positive reference voltage to a positive resistance string. The second supply voltage is less than the first supply voltage. The negative polarity buffer receives the second supply voltage and a third supply voltage to output a negative reference voltage to a negative resistance string. The third supply voltage is less than the second supply voltage.

This application claims the benefit of Taiwan application Serial No. 103104354, filed Feb. 11, 2014, the subject matter of which is incorporated herein by reference.

### BACKGROUND OF THE INVENTION

1. Field of the Invention

The invention relates in general to an electronic device, and more particularly to a buffer circuit, a display module and a display driving method.

2. Description of the Related Art

Along with the popularity of display products, liquid crystal display (LCD) products are widely used in people's everyday life. For an LCD to display frames properly, a digital to analog converter (DAC) is used to convert digital signals of image data into analog signals for driving liquid crystal molecules. During the process of converting the digital signals into the analog signals, the DAC employs several levels of gamma reference voltages.

Referring to FIG. 1, a schematic diagram of a positive resistance string, a negative resistance string, a positive polarity buffer and a negative polarity buffer is shown. Since liquid crystal molecules involve polarity conversion, a driver chip normally has a positive resistance string 32 and a negative resistance string 33 respectively representing the voltages at the positive and negative polarities of the driver chip. The positive resistance string 32 and the negative resistance string 33 are also referred as gamma resistors. A positive buffer amplifier 35 provides voltage to the positive resistance string 32. A negative buffer amplifier 36 provides voltage to the negative resistance string 33.

Each position of the positive buffer amplifier 35 on the positive resistance string 32 defines a dividing point, and each position of the negative buffer amplifier 36 on the negative resistance string 33 defines a dividing point. Then, each dividing point enters the DAC, which determines the output voltage and polarity of the driver chip according to the input signals. Since the resistance is inversely proportional to the current consumption, the driver chip will consume hundreds of micro-amperes to a few milliamps on the positive resistance string 32 and the negative resistance string 33, and such amount of current consumption occupies a large proportion of overall current consumption of the driver chip.

### SUMMARY OF THE INVENTION

The invention is directed to a buffer circuit, a display module and a display driving method.

According to one embodiment of the present invention, a buffer circuit is disclosed. The buffer circuit comprises a positive polarity buffer, a negative polarity buffer. The positive polarity buffer receives a first supply voltage and a second supply voltage to output a positive reference voltage to a positive resistance string. The second supply voltage is less than the first supply voltage. The negative polarity buffer receives the second supply voltage and a third supply voltage to output a negative reference voltage to a negative resistance string. The third supply voltage is less than the second supply voltage.

According to another embodiment of the present invention, a display module is disclosed. The display module comprises a panel, a positive resistance string, a negative resistance string, a buffer circuit and a driving circuit. The buffer circuit comprises a positive polarity buffer and a negative polarity buffer. The positive polarity buffer receives the first supply voltage and the second supply voltage to output a positive reference voltage to a positive resistance string. The second supply voltage is less than the first supply voltage. The negative polarity buffer receives the second supply voltage and a third supply voltage to output a negative reference voltage to a negative resistance string. The third supply voltage is less than the second supply voltage. The driving circuit drives the panel according to the first reference voltage and the second reference voltage.

According to an alternate embodiment of the present invention, a display driving method is disclosed. The display driving method comprises following steps. A first supply voltage and a second supply voltage are provided to a positive polarity buffer to output a positive reference voltage, wherein the second supply voltage is less than the first supply voltage. The second supply voltage and a third supply voltage are provided to a negative polarity buffer to output a negative reference voltage, wherein the third supply voltage is less than the second supply voltage. A panel is driven according to the positive reference voltage and the negative reference voltage.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a schematic diagram of a positive resistance string, a negative resistance string, a positive polarity buffer and a negative polarity buffer.

FIG. 2 is a schematic diagram of a display module according to a first embodiment.

FIG. 3 is a schematic diagram of a buffer circuit according to a first embodiment.

FIG. 4 is a schematic diagram of a positive resistance string coupled to three positive polarity buffers and a negative resistance string coupled to three negative polarity buffers.

FIG. 5 is a schematic diagram of a buffer circuit according to a second embodiment.

FIG. 6 is a schematic diagram of a display module according to a third embodiment.

FIG. 7 is a schematic diagram of m positive resistance strings coupled to n positive polarity buffers and m negative resistance strings coupled to n negative polarity buffers according to a fourth embodiment.

FIG. 8 is a schematic diagram of supply voltage VMID provided by supply voltage output circuit according to a fifth embodiment.

FIG. 9 is a schematic diagram of a display module according to a sixth embodiment.

FIG. 10 is a schematic diagram of a display module according to a seventh embodiment.

FIG. 11 is a flowchart of a display driving method according to an eighth embodiment.

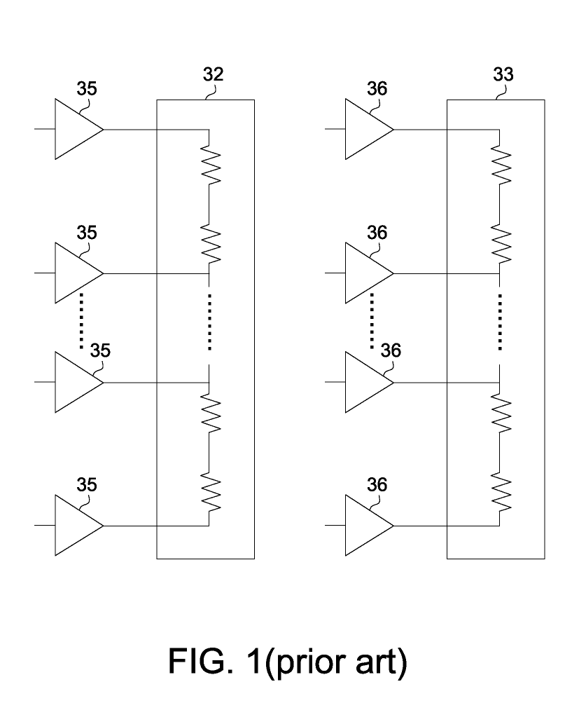

### DETAILED DESCRIPTION OF THE INVENTION

### First Embodiment

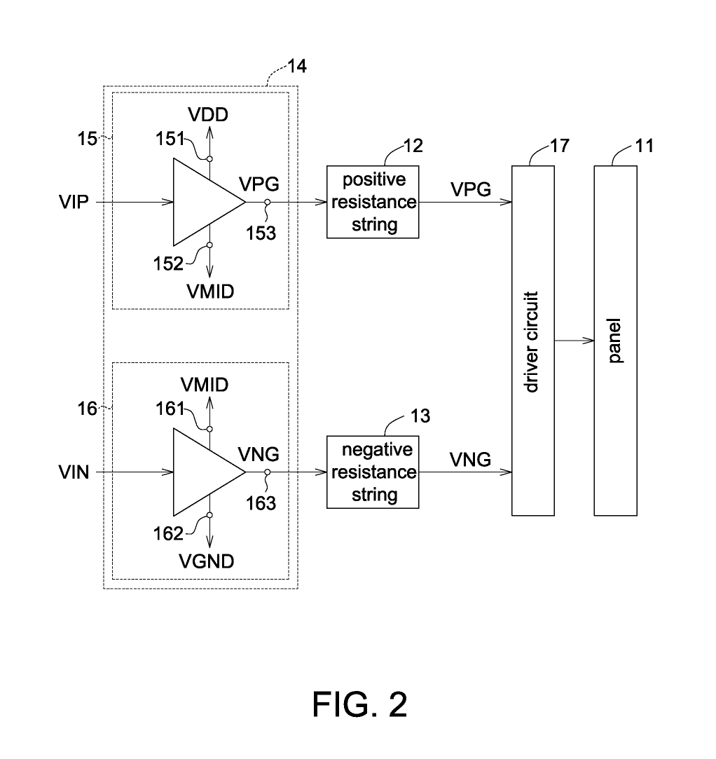

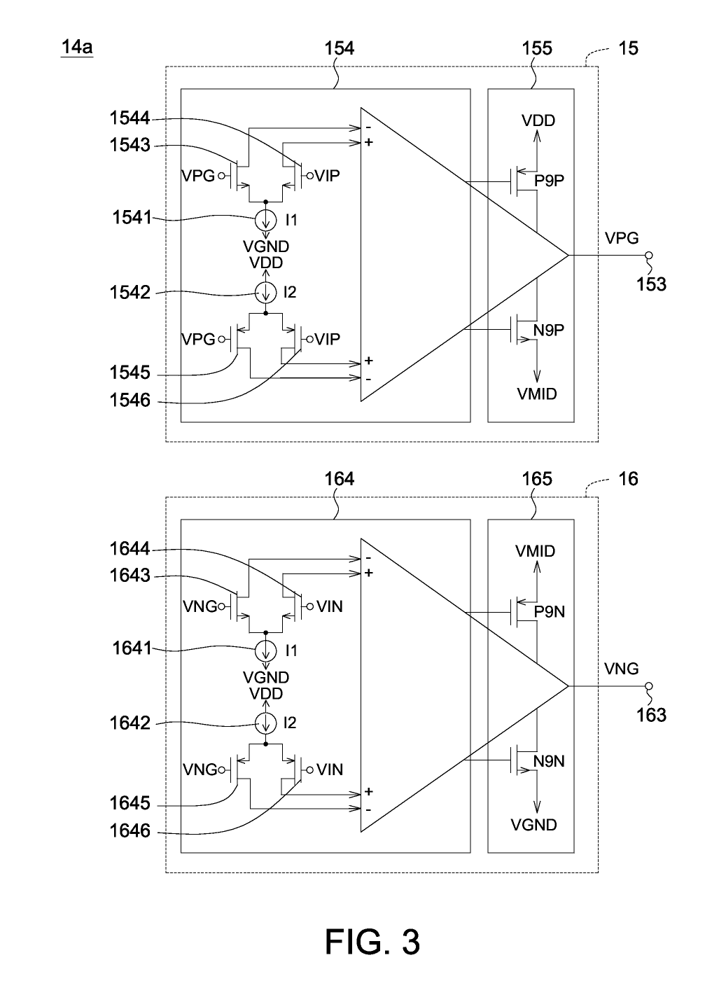

Refer to both FIG. 2 and FIG. 3. FIG. 2 is a schematic diagram of a display module according to a first embodiment. FIG. 3 is a schematic diagram of a buffer circuit according to a first embodiment. The display module 1 comprises a panel 11, a positive resistance string 12, a negative resistance string 13, a buffer circuit 14a and a driving circuit 17. The positive resistance string 12 and the negative resistance string 13 can both be realized by such as gamma resistors. The buffer circuit 14a comprises a positive polarity buffer 15 and a negative polarity buffer 16. The positive polarity buffer 15 and the negative polarity buffer 16 can both be realized by such as a gamma operational amplifier (Gamma OP). The driving circuit 17 can be realized by such as a source driver chip.

The positive polarity buffer 15 receives a supply voltage VDD and a supply voltage VMID to output a positive reference voltage VPG to a positive resistance string 12 according to an input voltage VIP. The supply voltage VMID is less than the supply voltage VDD. The negative polarity buffer 16 receives the supply voltage VMID and a supply voltage VGND to output a negative reference voltage VNG to a negative resistance string 13 according to an input voltage VIN. The supply voltage VGND is less than the supply voltage VMID, and the supply voltage VGND is substantially equivalent to the ground voltage. That is, the supply voltage VMID is between the supply voltage VDD and the supply voltage VGND. The driving circuit 17 drives the panel 11 according to the positive reference voltage VPG and the negative reference voltage VNG.

Furthermore, the positive polarity buffer 15 comprises a power supply 151, a power supply 152, an output supply 153, a positive input stage 154 and a positive output stage 155. The power supply 151 receives the supply voltage VDD, and the power supply 152 receives the supply voltage VMID. The output supply 153 is coupled to the positive resistance string 12. The positive input stage 154 is coupled to the positive output stage 155. The power supply 151 and the power supply 152 are coupled to the positive output stage 155 to supply the supply voltage VDD and the supply voltage VMID to the positive polarity buffer 15. The negative polarity buffer 16 comprises a power supply 161, a power supply 162, an output supply 163, a negative input stage 164 and a negative output stage 165. The power supply 161 receives the supply voltage VMID, and the power supply 162 receives the supply voltage VGND. The output supply 163 is coupled to the negative resistance string 13. The negative input stage 164 is coupled to the negative output stage 165. The power supply 161 and the power supply 162 are coupled to the negative output stage 165 to supply the supply voltage VMID and the supply voltage VGND to the negative polarity buffer 16.

The positive output stage 155 comprises an output transistor P9P and an output transistor N9P coupled to the output transistor P9P. The power supply 151 is coupled to a source of the output transistor P9P to supply the supply voltage VDD to the positive output stage 155. The power supply 152 is coupled to a source of the output transistor N9P to supply the supply voltage VMID to the positive output stage 155. The negative output stage 165 comprises an output transistor P9N and an output transistor N9N coupled to the output transistor P9N. The power supply 161 is coupled to a source of the output transistor P9N to supply the supply voltage VMID to the negative output stage 165. The power supply 162 is coupled to a source of the output transistor N9N to supply the supply voltage VGND to the negative output stage 165. The currents can be reused when the current at the positive output stage 155 is equivalent to the current at the negative output stage 165.

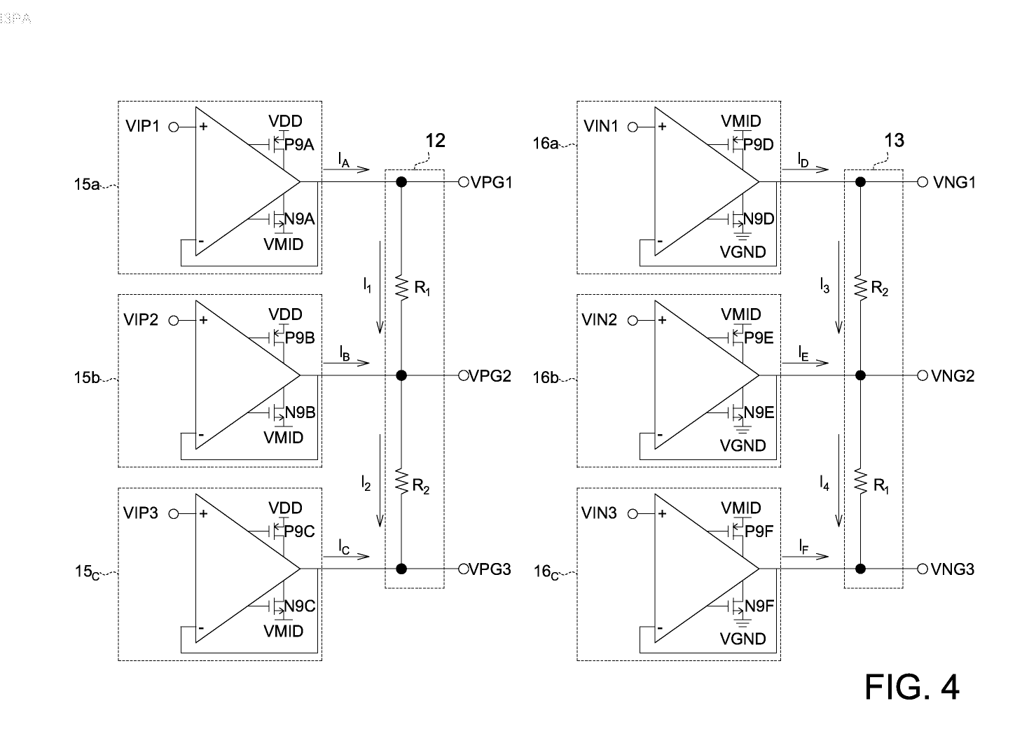

Referring to FIG. 4, a schematic diagram of a positive resistance string coupled to three positive polarity buffers and a negative resistance string coupled to three negative polarity buffers is shown. Positive polarity buffers 15a, 15b and 15c output positive reference voltages VPG1, VPG2 and VPG3 to the positive resistance string 12 according to input voltages VIP1, VIP2 and VIP3 respectively. Negative polarity buffers 16a, 16b and 16c output negative reference voltages VNG1, VNG2 and VNG3 to the negative resistance string 13 according to input voltages VIN1, VIN2 and VIN3 respectively.

The positive polarity buffer 15a comprises an output transistor P9A and an output transistor N9A. The positive polarity buffer 15b comprises an output transistor P9B and an output transistor N9B. The positive polarity buffer 15c comprises an output transistor P9C and an output transistor N9C. The negative polarity buffer 16a comprises an output transistor P9D and an output transistor N9D. The negative polarity buffer 16b comprises an output transistor P9E and an output transistor N9E. The negative polarity buffer 16c comprises an output transistor P9F and an output transistor N9F.

The positive resistance string 12 comprises a resistance divider R₁ and a resistance divider R₂ coupled to the resistance divider R₁. The negative resistance string 13 comprises a resistance divider R₁ and a resistance divider R₂ coupled to the resistance divider R₁. The positive polarity buffers 15a, 15b, and 15c and the negative polarity buffers 16a, 16b and 16c output currents I_{A}, I_{B}, I_{C}, I_{D}, I_{E} and I_{F} respectively. The currents I₁ and I₂ flow through the resistance dividers R₁ and R₂ of the positive resistance string 12 respectively. The currents I₃ and I₄ flow through the resistance dividers R₂ and R₁ of the negative resistance string 13 respectively.

The positive resistance string 12 takes the current I_{A} from the supply voltage VDD. Then, the current I_{A} flows to the positive resistance string 12 via the output transistor P9A, and further flows to the supply voltage VMID via the output transistor N9C. The negative resistance string 13 takes the current I_{D} via the supply voltage VMID. Then, the current I_{D} flows to the negative resistance string 13 via the output transistor P9D, and further flows to the supply voltage VGND via the output transistor N9F. If the resistance at the positive resistance string 12 is equivalent to the resistance at the negative resistance string 13 and the voltage difference between two ends of the positive resistance string 12 is equivalent to the voltage difference between two ends of the negative resistance string 13, then the voltage and current of the positive resistance string 12 are symmetric to the voltage and current of the negative resistance string 13. In comparison to the design of operating the positive polarity buffers 15a, 15b, and 15c and the negative polarity buffers 16a, 16b and 16c by using the supply voltages VDD and VGND, the design of the present embodiment can reduce current consumption to a half. If the positive resistance string 12 and the negative resistance string 13 are asymmetric or have different bias points, then current deficiency will be compensated by the supply voltage VMID or current surplus will overflow from the supply voltage VMID. Regardless whether the resistance at the positive resistance string 12 is equivalent to the resistance of the negative resistance string 13 or the voltage difference between two ends of the positive resistance string 12 is equivalent to the voltage difference between two ends of the negative resistance string 13, the above embodiments can achieve the object of lower current consumption.

### Second Embodiment

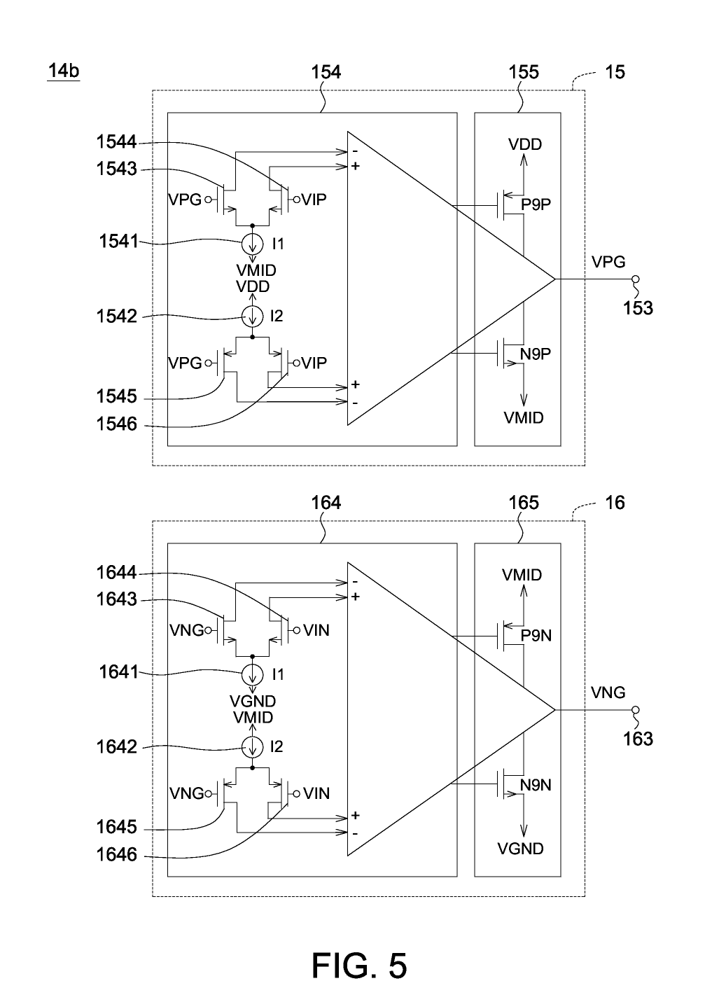

Refer to both FIG. 2 and FIG. 5. FIG. 5 is a schematic diagram of a buffer circuit according to a second embodiment. The second embodiment is different from the first embodiment mainly in that the power supply 151 and the power supply 152 are coupled to the positive input stage 154 of a buffer circuit 14b to supply the supply voltage VDD and the supply voltage VMID to the positive polarity buffer 15. The power supply 161 and the power supply 162 are coupled to the negative input stage 164 of a buffer circuit 14b to supply the supply voltage VMID and the supply voltage VGND to the negative polarity buffer 16.

The positive input stage 154 comprises current sources 1541, 1542, and 1543 and input resistors 1544, 1545 and 1546. The input resistors 1543 and 1544 are coupled to the current source 1541. The input resistors 1545 and 1546 are coupled to the current source 1542. The power supply 152 is coupled to the current source 1541 to supply the supply voltage VMID to the positive input stage 154. The power supply 151 is coupled to the current source 1542 to supply the supply voltage VDD to the positive input stage 154.

The negative input stage 164 comprises current sources 1641, 1642, and 1643 and input resistors 1644, 1645 and 1646. The input resistors 1643 and 1644 are coupled to the current source 1641. The input resistors 1645 and 1646 are coupled to the current source 1642. The power supply 162 is coupled to the current source 1641 to supply the supply voltage VGND to the negative input stage 164. The power supply 161 is coupled to the current source 1642 to supply the supply voltage VMID to the negative input stage 164.

### Third Embodiment

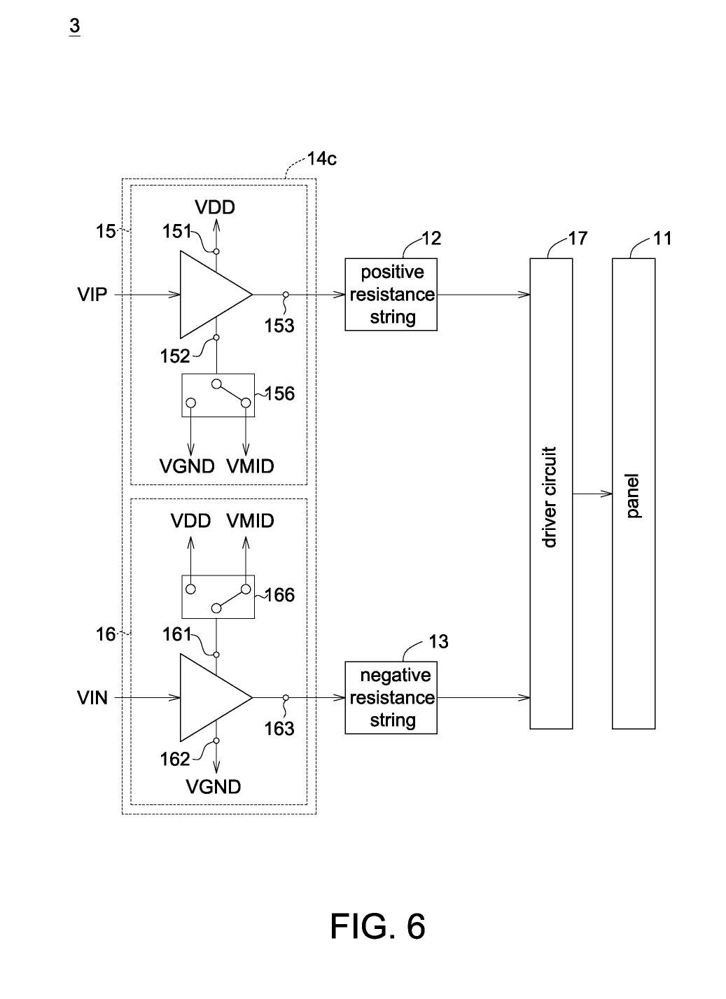

Referring to FIG. 6, a schematic diagram of a display module according to a third embodiment is shown. The third embodiment is different from the first embodiment mainly in that buffer circuit 14c of the display module 3 further comprises selection switches 156 and 166. The selection switch 156 outputs the supply voltage VMID or the supply voltage VGND to the positive polarity buffer 15. The selection switch 166 outputs the supply voltage VMID or the supply voltage VDD to the negative polarity buffer 16. When the selection switch 156 outputs the supply voltage VMID to the positive polarity buffer 15 and the selection switch 166 outputs the supply voltage VMID to the negative polarity buffer 16, the object of lower current consumption can be achieved.

### Fourth Embodiment

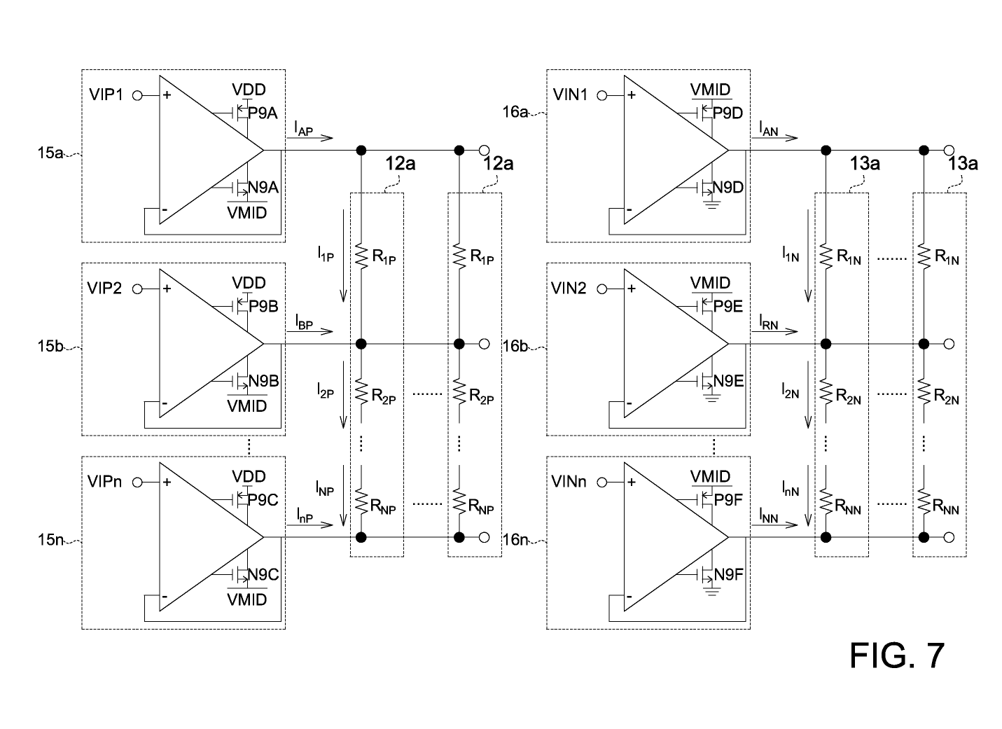

Referring to FIG. 7, a schematic diagram of m positive resistance strings coupled to n positive polarity buffers and m negative resistance strings coupled to n negative polarity buffers according to a fourth embodiment is shown. The positive polarity buffers 15a˜15n output positive reference voltages VPG1˜VPGn to m positive resistance strings 12a according to input voltages VIP1˜VIPn respectively, wherein n and m both are a positive integer greater than 1. The m positive resistance strings 12a comprises resistance dividers R_{1P}˜R_{NP}, wherein the m positive resistance strings 12a are disposed in parallel. The negative polarity buffers 16a˜16n output the negative reference voltages VNG1˜VNGn to m negative resistance strings 13a according to the input voltages VIN1˜VINn respectively. The negative resistance strings 13a comprise resistance dividers R_{1N}˜R_{NN}, wherein the m negative resistance strings 13a are disposed in parallel. The positive polarity buffers 15a˜15n and the negative polarity buffers 16a˜16n output currents I_{AP}˜I_{NP} and currents I_{AN}˜I_{NN} respectively. The currents I_{1P}˜I_{nP} flow through the resistance dividers R_{1P}˜R_{NP} respectively. The currents I_{1N}˜I_{nN} flow through the resistance dividers R_{1N}˜R_{NN} respectively.

### Fifth Embodiment

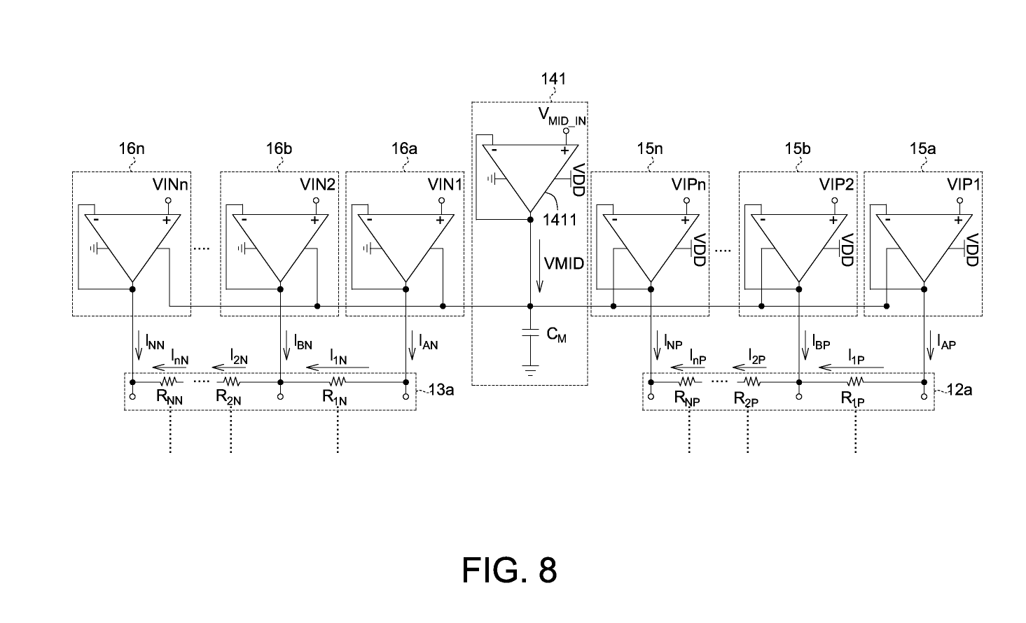

Referring to FIG. 7 and FIG. 8. FIG. 8 is a schematic diagram of supply voltage VMID provided by supply voltage output circuit according to a fifth embodiment. The fifth embodiment is different from the fourth embodiment mainly in that the buffer circuit of the fifth embodiment further comprises a supply voltage output circuit 141. The supply voltage output circuit 141 comprises a medium voltage buffer 1411 and a capacitor C_{M}. However, the implementation of the supply voltage output circuit 141 is not limited to above exemplification. In some embodiments, the supply voltage output circuit 141 can also be realized by a low drop out (LDO) linear voltage regulator or a back converter.

### Sixth Embodiment

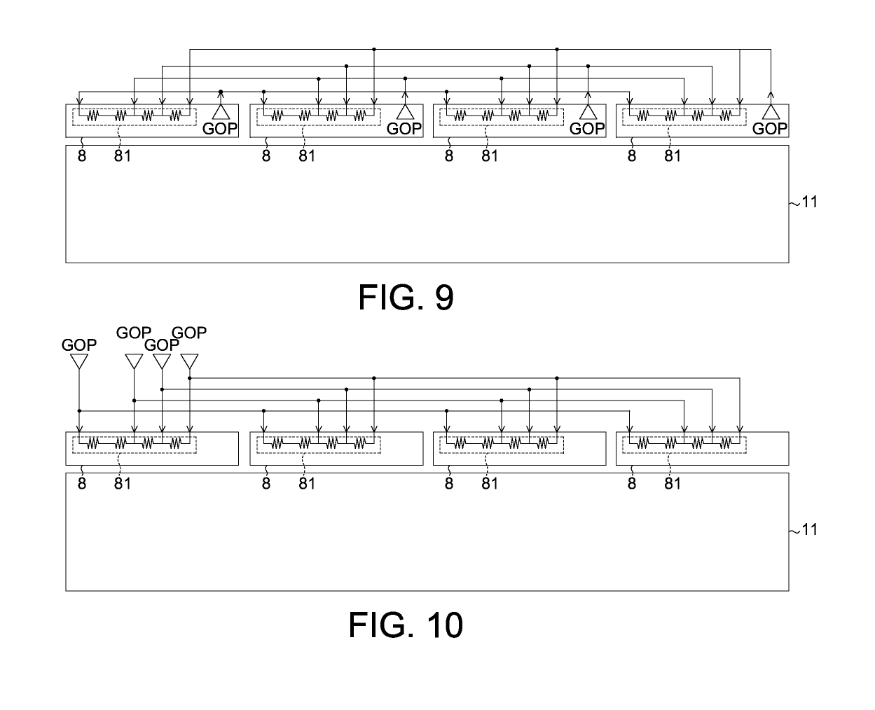

Refer to FIG. 2 and FIG. 9. FIG. 9 is a schematic diagram of a display module according to a sixth embodiment. The aforementioned positive and negative resistance strings are in-built in the source driver chip 8 like the resistance string 81 of FIG. 9, and the aforementioned positive and negative polarity buffers are in-built in the source driver chip 8 like the buffer GOP of FIG. 9.

### Seventh Embodiment

Refer to FIG. 2 and FIG. 10. FIG. 10 is a schematic diagram of a display module according to a seventh embodiment. The aforementioned positive and negative resistance strings are in-built in the source driver chip 8 like the resistance string 81 of FIG. 9, and the aforementioned positive and negative polarity buffers are not in-built in the source driver chip 8 like the buffer GOP of FIG. 10. In other words, the aforementioned positive and negative polarity buffers are disposed outside the source driver chip 8 like the buffer GOP of FIG. 10.

### Eighth Embodiment

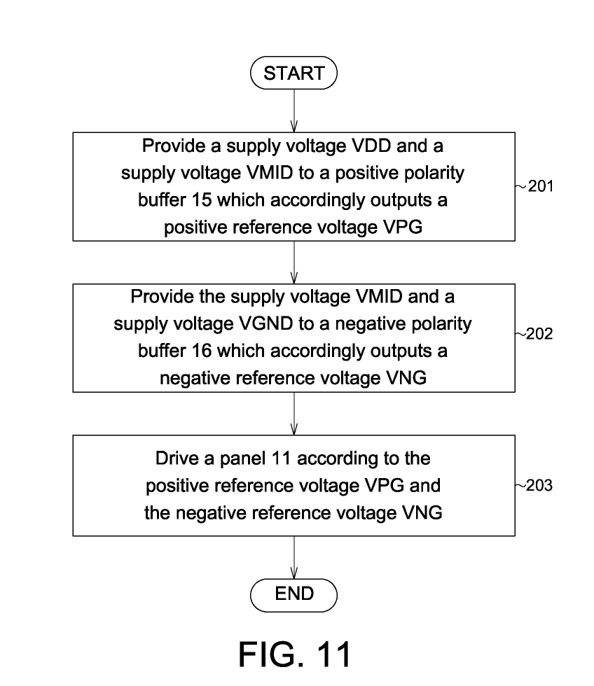

Referring to FIG. 2 and FIG. 11. FIG. 11 is a flowchart of a display driving method according to an eighth embodiment. The display driving method comprises following steps. Firstly, the method begins at step 201, a supply voltage VDD and a supply voltage VMID are supplied to a positive polarity buffer 15 which accordingly outputs a positive reference voltage VPG. Next, the method proceeds to step 202, the supply voltage VMID and a supply voltage VGND are provided to a negative polarity buffer 16 which accordingly outputs a negative reference voltage VNG. Then, the method proceeds to step 203, a panel 11 is driven according to the positive reference voltage VPG and the negative reference voltage VNG.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A buffer circuit, comprising:
a positive polarity buffer for receiving a first supply voltage and a second supply voltage to output a positive reference voltage to a positive resistance string, wherein the second supply voltage is less than the first supply voltage; and
a negative polarity buffer for receiving the second supply voltage and a third supply voltage to output a negative reference voltage to a negative resistance string, wherein the third supply voltage is less than the second supply voltage.

2. The buffer circuit according to claim 1, wherein the positive polarity buffer comprises:
a first power supply for receiving the first supply voltage;
a second power supply for receiving the second supply voltage; and
a first output supply coupled to the positive resistance string.

3. The buffer circuit according to claim 2, wherein the negative polarity buffer comprises:
a third power supply for receiving the second supply voltage;
a fourth power supply for receiving the third supply voltage; and
a second output supply coupled to the negative resistance string.

4. The buffer circuit according to claim 3, wherein the positive polarity buffer further comprises a positive input stage and a positive output stage; the positive input stage is coupled to the positive output stage; the first power supply and the second power supply are coupled to the positive output stage; the negative polarity buffer comprises a negative input stage and a negative output stage; the negative input stage is coupled to the negative output stage; the third power supply and the fourth power supply are coupled to the negative output stage.

5. The buffer circuit according to claim 4, wherein the positive output stage comprises a first output transistor and a second output transistor; the second output transistor is coupled to the first output transistor; the first power supply is coupled to a source of the first output transistor; the second power supply is coupled to a source of the second output transistor; the negative output stage comprises a third output transistor and a fourth output transistor; the fourth output transistor is coupled to the third output transistor; the third power supply is coupled to a source of the third output transistor; the fourth power supply is coupled to a source of the fourth output transistor.

6. The buffer circuit according to claim 3, wherein the positive polarity buffer further comprises a positive input stage and a positive output stage; the positive input stage is coupled to the positive output stage; the first power supply and the second power supply are coupled to the positive input stage; the negative polarity buffer comprises a negative input stage and a negative output stage; the negative input stage is coupled to the negative output stage; the third power supply and the fourth power supply are coupled to the negative input stage.

7. The buffer circuit according to claim 6, wherein the positive input stage comprises a first current source, a second current source, a first input resistor, a second input resistor, a third input resistor and a fourth input resistor; the first input resistor and the second input resistor are coupled to a first current source; the third input resistor and the fourth input resistor are coupled to a second current source; the second power supply is coupled to the first current source; the first power supply is coupled to the second current source; the negative input stage comprises a third current source, a fourth current source, a fifth input resistor, a sixth input resistor, a seventh input resistor and an eighth input resistor; the fifth input resistor and the sixth input resistor are coupled to a third current source; the seventh input resistor and the eighth input resistor are coupled to a fourth current source; the fourth power supply is coupled to the third current source; the third power supply is coupled to the fourth current source.

8. The buffer circuit according to claim 1, further comprising:
a first selection switch for outputting the second supply voltage or the third supply voltage to a positive polarity buffer; and
a second selection switch for outputting the second supply voltage or the first supply voltage to a negative polarity buffer.

9. The buffer circuit according to claim 1, wherein the positive resistance string, the negative resistance string, the positive polarity buffer and the negative polarity buffer are in-built in a source driver chip.

10. The buffer circuit according to claim 1, wherein the positive resistance string and the negative resistance string are in-built in a source driver chip; the positive polarity buffer and the negative polarity buffer are not in-built in the source driver chip.

11. The buffer circuit according to claim 1, further comprising:
a supply voltage output circuit for providing the second supply voltage.

12. The buffer circuit according to claim 11, wherein the supply voltage output circuit comprises a medium voltage buffer and a capacitor coupled to the medium voltage buffer.

13. The buffer circuit according to claim 11, wherein the supply voltage output circuit is a low drop out (LDO) linear voltage regulator.

14. The buffer circuit according to claim 11, wherein the supply voltage output circuit is a back converter.

15. A display module, comprising:
a panel;
a positive resistance string;
a negative resistance string;
a buffer circuit, comprising:
a positive polarity buffer for receiving a first supply voltage and a second supply voltage to output a positive reference voltage to a positive resistance string, wherein the second supply voltage is less than the first supply voltage; and
a negative polarity buffer for receiving the second supply voltage and a third supply voltage to output a negative reference voltage to a negative resistance string, wherein the third supply voltage is less than the second supply voltage; and
a driving circuit for driving the panel according to the positive reference voltage and the negative reference voltage.

16. A display driving method, comprising:
providing a first supply voltage and a second supply voltage to a positive polarity buffer which accordingly outputs a positive reference voltage, wherein the second supply voltage is less than the first supply voltage;
providing the second supply voltage and a third supply voltage to a negative polarity buffer which accordingly outputs a negative reference voltage, wherein the third supply voltage is less than the second supply voltage; and
driving a panel according to the positive reference voltage and the negative reference voltage.
